(19) United States
(12) Patent Application Publication
(10) Pub. No.: US 2025/0310701 A1
(43) Pub. Date: Oct. 2, 2025

(54) HEARING SYSTEM

(71) Applicant: WIDEX A/S, Lynge (DK)

(72) Inventors: Dina LELIC, Copenhagen (DK); Nathan Joseph Paul Berwick, Spardorf (DE)

(73) Assignee: WIDEX A/S, Lynge (DK)

(21) Appl. No.: 19/097,194

(22) Filed: Apr. 1, 2025

Related U.S. Application Data
(60) Provisional application No. 63/572,631, filed on Apr. 1, 2024.

(51) Int. Cl. H04R 25/00

(52) U.S. Cl. CPC H04R 25/30

(57) ABSTRACT

A hearing system includes at least one hearing aid. The hearing system is configured to detect a situation likely to invoke a positive listening experience and in response hereto prompting the hearing system user to report whether a positive listening experience has been encountered.

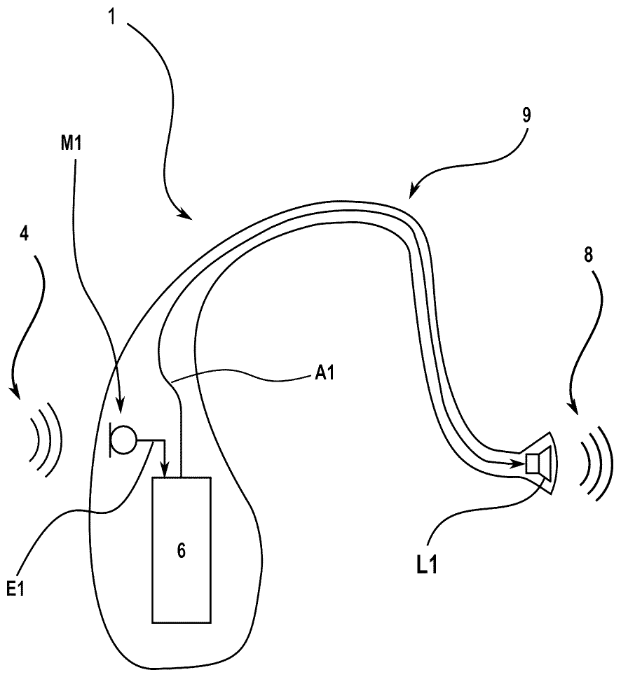

The present invention relates to a hearing system.

### BACKGROUND

Generally, a hearing system according to the invention is understood as meaning any device which provides an output signal that can be perceived as an acoustic signal by a user or contributes to providing such an output signal, and which has means which are customized to compensate for an individual hearing loss of the user or contribute to compensating for the hearing loss of the user. They are, in particular, hearing aids which can be worn on the body or by the ear, in particular on or in the ear, and which can be fully or partially implanted. However, some devices whose main aim is not to compensate for a hearing loss, may also be regarded as hearing systems, for example consumer electronic devices such as mobile phones and headsets, earbuds or other types of hearables devices provided they have measures for compensating for an individual hearing loss.

Within the present context a traditional hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor, and an acoustic output transducer. The signal processor is preferably a digital signal processor. The hearing aid is enclosed in a casing suitable for fitting behind or in a human ear.

Within the present context a hearing system may comprise a single hearing aid (a so called monaural hearing system) or comprise two hearing aids, one for each ear of the hearing aid user (a so called binaural hearing system). Furthermore, the hearing system may comprise an external device, such as a smart phone having software applications adapted to interact with other devices of the hearing system. Thus, within the present context the term “hearing system device” may denote a hearing aid or an external device.

The mechanical design of hearing aids has developed into a number of general categories. As the name suggests, Behind-The-Ear (BTE) hearing aids are worn behind the car. To be more precise, an electronics unit comprising a housing containing the major electronics parts thereof is worn behind the car. An earpiece for emitting sound to the hearing aid user is worn in the car, e.g. in the concha or the car canal. In a traditional BTE hearing aid, a sound tube is used to convey sound from the output transducer, which in hearing aid terminology is normally referred to as the receiver, located in the housing of the electronics unit and to the car canal. In other types of hearing aids, a conducting member comprising electrical conductors conveys an electric signal from the housing and to a receiver placed in the earpiece in the car. Such hearing aids are commonly referred to as Receiver-In-The-Ear (RITE) hearing aids. In a specific type of RITE hearing aids the receiver is placed inside the car canal. This category is sometimes referred to as Receiver-In-Canal (RIC) hearing aids.

In-The-Ear (ITE) hearing aids are designed for arrangement in the car, normally in the funnel-shaped outer part of the car canal. In a specific type of ITE hearing aids the hearing aid is placed substantially inside the car canal. This category is sometimes referred to as Completely-In-Canal (CIC) hearing aids. This type of hearing aid requires an especially compact design in order to allow it to be arranged in the car canal, while accommodating the components necessary for operation of the hearing aid.

Hearing loss of a hearing impaired person is normally frequency-dependent. This means that the hearing loss of the person varies depending on the frequency. Therefore, when compensating for hearing losses, it is advantageous to utilize frequency-dependent amplification.

Additionally, the amplification is level dependent and adapted for compressing the signal in order to control the dynamic range of the output of the hearing aid. The compression can be regarded as an automatic adjustment of the gain levels for the purpose of improving the listening comfort of the user of the hearing aid and the compression may therefore be denoted Automatic Gain Control (AGC). The AGC also provides the gain values required for alleviating the hearing loss of the person using the hearing aid. Compression may be implemented in the way described in the international application WO-A1-9934642.

Finally hearing aids normally comprise anti-feedback algorithms for continuously measuring input levels and output levels as a function of frequency for the purpose of continuously controlling acoustic feedback instability by providing cancellation signals and through lowering of the frequency dependent gain settings when necessary.

Additionally, it has been suggested to use models for the prediction of the intelligibility of speech after a transmission though a linear system. The most well-known of these models is the “articulation index”, the speech intelligibility index, SII, and the “speech transmission index”, STI, but other indices exist.

The ANSI S3.5-1969 standard (revised 1997) provides methods for the calculation of the speech intelligibility index, SII. The SII makes it possible to predict the intelligible amount of the transmitted speech information, and thus, the speech intelligibility in a linear transmission system. The SII is a function of the system's transfer function and of the acoustic input, i.e. indirectly of the speech spectrum at the output of the system. Furthermore, it is possible to take both the effects of a masking noise and the effects of a hearing aid user's hearing loss into account in the SII. The SII is always a number between 0 (speech is not intelligible at all) and 1 (speech is fully intelligible). The SII is, in fact, an objective measure of the system's ability to convey speech intelligibility and hereby hopefully making it possible for the listener to understand what is being said.

An increase of gain in the hearing aid will always lead to an increase in the loudness of the amplified sound, which may in some cases lead to an unpleasantly high sound level, thus creating loudness discomfort for the hearing aid user.

The loudness of the output of the hearing aid may be calculated according to a loudness model, e.g. by the method described in an article by B. C. J. Moore and B. R. Glasberg “A revision of Zwicker's loudness model”, Acta Acustica Vol. 82 (1996) 335-345, which proposes a model for calculation of loudness in normal-hearing and hearing-impaired subjects. The model is designed for steady state sounds, but an extension of the model allows calculations of loudness of shorter transient-like sounds, too. Reference is made to ISO standard 226 (ISO 1987) concerning equal loudness contours.

EP-B1-1522206 discloses a hearing aid and a method of operating a hearing aid wherein speech intelligibility is improved based on frequency band gain adjustments based on real-time determinations of speech intelligibility and loudness, and which is suitable for implementation in a processor in a hearing aid.

This type of hearing aid and operation method requires the capability of increasing or decreasing the gain as a function of frequency. Additionally, the frequency dependent gain may depend on the current sound situation. For bands with high noise levels, e.g., it may be advantageous to decrease the gain, while an increase of gain can be advantageous in bands with low noise levels, in order to enhance the SII. However, such a simple strategy will not always be an optimal solution, as the SII also takes inter-band interactions, such as mutual masking, into account. A precise calculation of the SII is therefore necessary.

While such a system is generally advantageous it has been found that the amount of gain preferred by an individual hearing aid user may differ from user to user due to the preferences of the individual hearing aid user.

It is not feasible to compute a general relationship between the SII and a given change in amplification gain analytically and therefore some kind of numerical optimization routine is needed to determine this relationship in order to determine the particular amplification gain that gives the largest SII value. However, deriving an optimization routine that provides optimized speech intelligibility in real time using the limited processing resources in a hearing aid is in no way straightforward.

However, in most, if not all, of these gain adjustment methods, the gain levels are modified according to algorithms that have been predefined to reflect requirements for generalized situations, which means that these methods are not specifically optimized neither for the specific user nor for the specific sound environments the specific user is experiencing.

Thus, speech enhancement has been a significant interest to the signal processing community already from the 1960's and earlier, see e.g. Y. Ephraim and D. Malah: “Speech enhancement using a minimum mean-square error short-time spectral amplitude estimator,” IEEE Trans. Acoustics, Speech and Signal Processing, vol. ASSP-32, no. 6, pp. 1109-1121 December 1984.

The basic problem concerns the estimation of a clean underlying speech signal from one or more noisy/degraded signals. A more general problem is that of speaker separation, in which one attempts to separate a mixture of (potentially noisy) speech signals into separate clean speech signals.

Hearing impairment limits the ability to cope with background noise. Therefore, a noise reduction (speech enhancement) system is usually seen as an integral part of a hearing aid. When asked about desired improvements of their hearing aids, users often request more effective systems for attenuating (or otherwise managing) background noise.

Traditionally, speech enhancement systems have been based on manually devised statistical models of speech and noise, which in turn lead to signal processing based methods of optimally removing noise from noisy speech. These approaches are limited by the ability to accurately describing speech and noise by statistical models, while keeping these models simple enough to allow closed form derivations of the relevant estimators.

One particularly difficult hearing situation is the so called cocktail party situation where multiple speakers are present at the same time and typically positioned close together.

It has therefore been suggested to provide separation of speakers in order to suppress undesired speakers. Traditionally this has been provided using e.g. various beamforming techniques and more recently speaker separation (which in the following may also be denoted source separation) has been demonstrated based on specifically trained neural networks.

Recently, machine learning (artificial intelligence) has revolutionized speech enhancement (along with many other scientific disciplines). Speech enhancement is essentially a simple regression problem, where a clean signal is estimated from a noisy counterpart. Plentiful training data can easily be obtained by mixing clean speech recordings with separate noise recordings. Proposed methods vary primarily according to their model architecture (how the neural network is configured), the data used for training, and the objective (loss) optimized during training.

However, neither neural network based speech enhancement methods are free from various sound artefacts that results in a less than optimal speech intelligibility provided by even the most advanced neural network method.

It is therefore a feature of the invention to provide a hearing system that is configured to further improve the speech intelligibility experienced by the user of the hearing system and in as many different situations as possible.

It is another feature of the invention to provide a hearing system configured to motivate especially first time hearing system users to endure wearing the hearing aid system even though it may be challenging, exhausting or even frustrating to get used to, e.g. all the additional (i.e. previously in-audible) sounds provided by a hearing system and to the various sound artefacts that some hearing systems introduce.

### SUMMARY

The invention in a first aspect provides a hearing system according to claim 1.

Further advantageous features appear from the dependent claims.

Still other features of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawings:

The FIGURE illustrates highly schematically a hearing system according to an embodiment of the invention.

### DETAILED DESCRIPTION

It is noted that in the following the terms “soundscape” and “sound environment” will be considered to be interchangeable.

Likewise the terms “hearing system user”, “hearing aid user” and simply “user” may be used interchangeably.

Reference is now given to the FIGURE, which illustrates highly schematically a hearing aid 1 (i.e. a monaural hearing system). The hearing aid 1, is in the present case embodied as a BTE device. However, the following considerations remain valid for other hearing aid designs (such as RITE, RIC or ITE), and also for more general hearing systems not primarily intended and designed for providing support in case of a hearing loss.

The hearing aid 1 includes an acousto-electric first input transducer M1, which in the present case is given by a microphone. The first input transducer M1 is configured to generate an electrical first input signal E1 from an environment sound 4. The first input signal E1 is processed in a signal processing unit 6, wherein a first output signal A1 is derived from the first input signal E1 by means of frequency-dependent signal processing, which in general may include frequency-dependent amplification and/or compression, as well as other signal processing techniques such as noise reduction or speech enhancement. Part of said signal processing for obtaining the first output signal A1 may be implemented by a corresponding filter in the signal processing unit 6.

Finally, an electro-acoustic output transducer L1 generates an output sound signal 8 from the first output signal A1. In the present context, an electro-acoustic output transducer shall be generally understood as any device which is intended, designed and configured to convert an electrical signal into a corresponding sound signal, whereby voltage and/or current fluctuations in the electrical signal are converted into corresponding amplitude fluctuations in the sound signal, and may in particular be given as a loudspeaker, or a so-called balanced metal case receiver, but also as a bone conduction receiver. Here, the output transducer L1 is preferably given by a loudspeaker positioned in an earpiece 9.

The hearing aid 1 may include one or more additional input transducers (not shown in the FIGURE), each of which configured to generate a respective additional input signal from the environment sound. In this case, the one or more additional signals are also fed to the signal processing unit 6, along with the first input signal E1, and the first output signal A1 is typically derived from both the first input signal E1 and the additional input signal(s). Furthermore, the hearing aid 1 may be part of a hearing system (not shown), said hearing system possibly including another hearing aid (i.e., a binaural hearing system with two hearing aids, each of which configured to be worn by the user at one of his ears) and/or an external device connectable to the hearing instrument 1 (such as, e.g., a mobile phone for, inter alia, controlling the operation and/or certain functions of the hearing device 1).

The validity neither of the concepts surrounding the invention as explained above nor of the considerations presented below are compromised by the presence of additional input signals and/or another hearing aid or external device.

The inventors have investigated the impact from focusing on positive listening experiences on speech intelligibility for both experienced and first-time hearing aid users.

In the study of first time users the participants were fitted with hearing aids and underwent initial speech-in-noise testing. Over a four-week period, both groups wore the hearing aids and reported daily usage via text messages. The Positive Focus (in the following abbreviated PF) group was additionally instructed to focus on positive listening experiences and report these experiences daily. After the four-week trial, participants completed the Speech, Spatial and Qualities of Hearing scale questionnaire and repeated the speech-in-noise testing. Results showed that the PF group experienced significant improvements in both subjective and objective measures of speech intelligibility compared to the control group.

Overall, both studies demonstrate that focusing on positive listening experiences can enhance speech intelligibility, with the first-time users study providing additional insights into the benefits for new hearing aid users.

It is generally known that a positive mind-set most likely is beneficial. Consequently, a multitude of methods directed at contributing to a positive mind-set already exist. These include:
practicing active listening, which involves fully concentrating, understanding, responding, and remembering what is being said, this can help users stay engaged and appreciative of the potential positive interactions resulting at least partly from the active listening.
remembering to regularly acknowledge and celebrate successful listening experiences, this can be obtained by the user through verbal praise or by keeping a journal of positive listening moments.
carrying out mindfulness techniques that will help users stay present and focused during conversations, which can reduce anxiety and at least hereby improve the quality of listening experiences.
setting achievable listening goals and gradually increase the complexity of listening environments whereby confidence can be built and progress can be highlighted.
creating a supportive and encouraging environment where users feel comfortable sharing their listening experiences and challenges.
receiving regular, constructive feedback on listening performance. This can help users identify areas of improvement and reinforce positive behaviors.
encouraging users to engage in social activities and group conversations, because positive social interactions can enhance listening experiences and provide opportunities for practice.

Thus by implementing such strategies, hearing aid users can develop a more positive outlook on their listening experiences, which can lead to improved speech intelligibility and overall satisfaction with their hearing aids.

However, these strategies may be less than optimal, e.g. as a consequence of requiring quite an investment of psychological resources and furthermore the ability to access and engage in social activities that may not be readily and frequently available for everyone.

Consequently, there is a need for solutions that can facilitate positive listening experiences for hearing system users.

According to an embodiment a hearing system is configured to detect a situation likely to invoke a positive listening experience in a user of the hearing system and configured to prompt, in response to said detection, said hearing system user to report whether a positive listening experience has been encountered. The inventors have found that by configuring a hearing system such that the hearing system user only is prompted when the hearing system has detected that it is likely that at positive hearing experience has been encountered then the benefit from positive listening can be enhanced while the risk of the hearing aid system user being annoyed by too frequent prompting is decreased.

Furthermore, according to an embodiment, said detection of a situation likely to invoke a positive listening experience in a user of the hearing system is based on carrying out a detection of a sound environment (such as a soundscape, i.e. a mixture of different sounds that are heard in a specific place) including at least one nature sound.

According to an embodiment a neural network based detection method is linked to a sound classifier in order to detect whether the hearing system user is in a natural sound environment.

According to another embodiment a traditional sound classifier, as is well known by the skilled person suffices.

According to a more specific embodiment said nature sound is one of the following group of nature sounds: falling rain, buzzing insects, singing or chirping birds, crunching gravel, crunching withered leaves, rustling leaves in the trees, the sound of waves rolling onto a shore, the sound of water flowing in a river or stream.

According to other more specific embodiments the inventors have additionally found that positive listening experiences are also relatively often experienced in at least one of the following sound environments (soundscapes), that like the nature sounds can be detected using e.g. a sound classifier included in the hearing system:
social events including speech such as: family dinners, speaking with grandchildren, (cocktail) parties, restaurant visits and one to one conversations; and
focused listening such as: listening to music or watching a movie at home, attending a classical concert and going to the cinema or the theater.

According to another embodiment, that may be combined with the previous embodiments, or used independently, said detection of a situation likely to invoke a positive listening experience in a user of the hearing system is based on:
using a sound classifier to detect a change in a sound environment from one type of sound environment and into a novel sound environment; and
in response to the hearing system user having spent at least a first duration of time in said novel sound environment detecting said situation likely to invoke a positive listening experience.

According to a more specific embodiment said first duration of time is in the range of 10 to 60 minutes or in the range of 20 to 40 minutes. The inventors have found that durations of time within these limits provides a good compromise between the sometimes conflicting goals of:
missing the chance of prompting a hearing system user to (subsequently) reflect and report on the listening experience of a novel sound environment because the user left the sound environment before the selected time duration was spent; and
prompting the user unnecessarily frequent, because the user did not stay sufficiently long in said sound environment to be able to form an opinion about the encountered listening experience.

According to another embodiment, that may be combined with the previous embodiments, or used independently, said detection of a situation likely to invoke a positive listening experience in a user of the hearing system is based on:
determining a current position of the hearing system and detecting said situation (likely to invoke a positive listening experience) if said current position matches a position of a location that previously has been determined to (likely) invoke a positive listening experience.

According to another embodiment said step of determining a current position of the hearing system includes receiving a localization signal such as a Global Positioning System signal.

According to an embodiment said prompting of the hearing system user to report whether a positive listening experience has been encountered is based on using an interactive portable computer device adapted to provide to the hearing system user at least one of an audible or visual request to report a positive listening experience and in response hereto receive said report. Preferably said interactive portable device is part of said hearing system.

According to another embodiment said prompting of the hearing system user to report whether a positive listening experience has been encountered is based on adapting at least one hearing aid of the hearing system to provide to the user an audible request to report a positive listening experience and in response hereto receive said report. According to a more specific embodiment said hearing system is adapted to receive said report simply by detecting and subsequently recording the hearing system users voice by using the microphones of the hearing system and recording the reply.

According to one embodiment the hearing system (preferably a binaural hearing system) is capable of detecting the hearing system users voice above other voices in the sound environment by using an adaptive beamformer to focus in the direction of the hearing aid system users mouth. Alternatively, various own voice detection algorithms can be applied, such as own voice detection algorithms based on neural networks.

Ambient nature sounds, particularly birds singing, are generally considered to be a desired sound for hearing system users. However, these sounds are often improperly processed typically as a result of the applied noise reduction algorithm(s) and/or a result of high compression ratios. High compression ratios may lead to a negatively affected neural processing of sounds.

Consequently and according to an embodiment the hearing system is further configured to adapting, in response to a detected situation likely to invoke a positive listening experience, signal processing characteristics specifically adapted to improve the hearing system users perception of said positive listening experience.

More specifically said adapting of signal processing characteristics includes at least one of: reducing compression ratio, raising compression thresholds, reducing the strength of at least one noise reduction algorithm, giving preference for omni-directional beamforming over directional beamforming and increasing the general sound pressure level in order to make low level nature/ambience sounds audible.

Additionally, according to an embodiment, said adapting of the signal processing characteristics includes postprocessing configured to decide upon the duration time for activating a specific feature, and to apply short duration switch capabilities to return to speech-focused processing.

Wherein said features, according to an embodiment, at least includes: reducing effect of noise reduction algorithms, switching to omnidirectional microphone processing, reducing the effect of compression and raising the sound pressure level in order to bring low level sounds (ambience) into the audible range.

Thus generally the adapted signal processing characteristics are characterized by providing changes relatively slowly, except, at least, in the case of, at least one of:
returning to speech processing as a result of a detection of speech; and
generally changing to some other sound environment in response to a classifier detection of this happening.

The inventors have found that these signal processing characteristics are especially well suited for improving hearing system users perception of nature sounds.

According to an embodiment the hearing system is adapted to only prompt hearing system users to report, whether a positive listening experience has been encountered, in a limited time period, with a duration between the first two and the first eight weeks of usage.

Dependent on whether the hearing system user is a first time user or a user of hearing system that has been fine tuned or otherwise updated, then the duration of the above mentioned limited time period for prompting may be given different values.

According to an embodiment the hearing system sends a daily prompt at the end of the day for the user to reflect on positive listening experiences throughout the day during the first couple of weeks, such as every day of the first two to eight weeks after receiving a new hearing system or after having the hearing system fine-tuned with a novel fitting.

In fact this approach can be used regardless of whether or not a situation likely to invoke a positive listening experience has been detected.

An advantage of making the prompting independent on a detecting a situation likely to invoke a positive listening experience is that it provides an easy way to ensure that the user is wearing the hearing system and hereby enables a hearing care professional to be pro-active and hereby e.g. offer the hearing system user additional help.

According to an embodiment, once the hearing system detects a change in sound environment, e.g. based on at least one of sound pressure level and general sound environment classification, and this classified sound environment is constant for a duration of at least 10 minutes or for a duration up to say at least 60 minutes, the hearing system, e.g. using a so called “app” in an external computing device being part of the hearing system, is adapted to indicate to the user that there has been a change in the sound environment, and prompt the user to reflect on whether any positive listening experiences has been encountered in the current sound environment.

Thus the inventors have found that positive listening experiences don't necessarily need to be related to a novel experience (despite the above given methods for detecting a novel sound environment) and sometimes the user don't even experience positive listening experiences as such—sometimes such positive experiences are internalized as positive everyday experiences that normally are taken for granted.

The inventors have found that this option of prompting independent on a detection of a situation likely to invoke a positive listening experience could be something that is active during the first couple of weeks after a receiving a novel new hearing aid or a known hearing aid with a novel hearing aid fitting (for experienced users) or after trying a hearing system for the first time.

Additionally, the inventors have found that at least for some users detection dependent and detection independent prompting can be combined, such that the hearing system user e.g. may be prompted at least once a day within the first weeks of usage (whether due to wearing a novel hearing system or due to having a novel hearing system fitting).

According to an embodiment, the hearing system is configured to prompt, in response to a detection of a situation likely to invoke a positive listening experience in a hearing system user, said hearing system user to report a positive listening experience.

Thus according to this embodiment the hearing system user is encouraged to actively try to search his mind for positive listening experiences.

According to an embodiment the hearing system is operationally connectable to at least one of an internet server and a cloud based fitting software, wherein at least one of said internet server and cloud based fitting software is configured to receive reported positive listening experiences; and in response hereto updating the hearing system using at least one of said internet server or said cloud based fitting software, to provide at least one of:
improved performance of said hearing system sound classifier's ability to detect a sound environment that is likely to invoke a positive listening experience; and
increased number of locations that previously has been determined to be likely to invoke a positive listening experience.

What is claimed is:

1. A hearing system comprising:
at least one hearing aid; and
at least one processor configured to:
detect a situation likely to invoke a positive listening experience in a user of the at least one hearing aid; and
prompt, in response to said detection, said user to report whether a positive listening experience has been encountered.

2. The hearing system according to claim 1;
wherein said detection is based on carrying out at least one of:
using a sound classifier to detect a sound environment comprising at least one nature sound and in response hereto detecting said situation likely to invoke a positive listening experience;
using a sound classifier to detect a plurality of social and focused listening situations and in response hereto detecting said situation likely to invoke a positive listening experience;
using a sound classifier to detect a change of sound environment from one sound environment into a novel sound environment and in response to the user having spent at least a first duration of time in said novel sound environment detecting said situation likely to invoke a positive listening experience; and
determining a current position of the hearing system and detecting said situation likely to invoke a positive listening experience if said current position matches a position of a location that previously has been determined to likely invoke a positive listening experience.

3. The hearing system according to claim 1, wherein said nature sound is selected from a group of nature sounds comprising: falling rain, buzzing insects, singing or chirping birds, crunching gravel, crunching withered leaves, rustling leaves in the trees, the sound of waves rolling onto a shore, the sound of water flowing in a river or stream.

4. The hearing system according to claim 2,
wherein said first duration of time is in the range of 10 to 60 minutes or in the range of 20 to 40 minutes.

5. The hearing system according to claim 1, wherein said prompting is based on carrying out at least one of:
using an interactive portable computer device, being part of said hearing system, to provide to the user at least one of an audible or visual request to report a positive listening experience and in response hereto receive said report, and
using the at least one hearing aid of the hearing system to provide to the user an audible request to report a positive listening experience by speaking and in response hereto receive said report by the microphones of the hearing system.

6. The hearing system according to claim 1, wherein the at least one processor is further configured to:
adapt, in response to a detected situation likely to invoke a positive listening experience, signal processing characteristics specifically adapted to improve the user's perception of said positive listening experience,
wherein said adapting of signal processing characteristics comprises at least one of:
reducing compression ratio;
raising compression thresholds;
reducing the strength of at least one noise reduction algorithm;
giving preference for omni-directional beamforming over directional beamforming, and
increasing the general sound pressure level.

7. The hearing system according to claim 1, wherein the hearing system is adapted to only prompt hearing system users to report, whether a positive listening experience has been encountered, in a limited time period, with a duration between the first two and the first eight weeks of usage.

8. The hearing system according to claim 1, wherein the prompting, in response to said detection, said user to report whether a positive listening experience has been encountered is replaced by:
prompting, in response to said detection, said user to report a positive listening experience.

9. The hearing aid system according to claim 1, being operationally connectable to at least one of an internet server and a cloud based fitting software, wherein at least one of said internet server and cloud based fitting software is configured to:
receiving said reported positive listening experiences; and in response hereto updating the hearing system using at least one of said internet server or said cloud based fitting software, to provide at least one of:
improved performance of said hearing system sound classifier's ability to detect a sound environment that is likely to invoke a positive listening experience; and
increased number of locations that previously has been determined to be likely to invoke a positive listening experience.

10. The hearing system according to claim 2, wherein said prompting is based on carrying out at least one of:
using an interactive portable computer device, being part of said hearing system, to provide to the user at least one of an audible or visual request to report a positive listening experience and in response hereto receive said report, and
using at least one hearing aid of the hearing system to provide to the user an audible request to report a positive listening experience by speaking and in response hereto receive said report by the microphones of the hearing system.

11. The hearing system according to claim 2, wherein the at least one processor is further configured to:
adapting, in response to a detected situation likely to invoke a positive listening experience, signal processing characteristics specifically adapted to improve the user's perception of said positive listening experience,
wherein said adapting of signal processing characteristics comprises at least one of:
reducing compression ratio;
raising compression thresholds;
reducing the strength of at least one noise reduction algorithm;
giving preference for omni-directional beamforming over directional beamforming, and
increasing the general sound pressure level.

12. The hearing system according to claim 2, wherein the hearing system is adapted to only prompt hearing system users to report, whether a positive listening experience has been encountered, in a limited time period, with a duration between the first two and the first eight weeks of usage.

13. The hearing system according to claim 2, wherein the prompting, in response to said detection, said user to report whether a positive listening experience has been encountered is replaced by:
prompting, in response to said detection, said user to report a positive listening experience.

14. The hearing aid system according to claim 2, being operationally connectable to at least one of an internet server and a cloud based fitting software, wherein at least one of said internet server and cloud based fitting software is configured to:
receiving said reported positive listening experiences; and in response hereto updating the hearing system using at least one of said internet server or said cloud based fitting software, to provide at least one of:
improved performance of said hearing system sound classifier's ability to detect a sound environment that is likely to invoke a positive listening experience; and
increased number of locations that previously has been determined to be likely to invoke a positive listening experience.
